(19) United States
(12) Patent Application Publication
(10) Pub. No.: US 2023/0099553 A1
(43) Pub. Date: Mar. 30, 2023

(54) METHOD, APPARATUS, AND SYSTEM FOR DETECTING A VEHICLE DOOR OPENING OR CLOSING EVENT BASED ON MOBILE DEVICE SENSOR DATA

(71) Applicant: HERE Global B.V., Eindhoven (NL)

(72) Inventors: Harel PRIMACK, Rishon Le-Zion (IL); Silviu ZILBERMAN, Rishon Le-Zion (IL); Ofri ROM, Ganey Tikva (IL)

(21) Appl. No.: 17/562,756

(22) Filed: Dec. 27, 2021

Related U.S. Application Data
(60) Provisional application No. 63/249,503, filed on Sep. 28, 2021.

(51) Int. Cl. B60R 25/34; B60R 25/32; G06Q 50/30

(52) U.S. Cl. CPC B60R 25/34; B60R 25/32; G06Q 50/30; G01C 21/3476

(57) ABSTRACT

An approach is provided for detecting a vehicle door opening or closing event based on sensor data collected during a vehicle idle/stop state. The approach, for example, involves collecting sensor data from one or more sensors of a vehicle, a mobile device in the vehicle, or a combination thereof. The approach also involves determining a time period when the vehicle is in an idle state based on the sensor data. The approach further involves determining a vehicle door open event or a vehicle door close event based on pressure sensor data from at least one pressure sensor of the mobile device collected during the time period. The approach further involves providing the vehicle door open event or the vehicle door close event as an output.

### RELATED APPLICATION

This application claims priority to U.S. Provisional Patent Application Ser. No. 63/249,503, filed Sep. 28, 2021, entitled “METHOD, APPARATUS, AND SYSTEM FOR DETECTING A VEHICLE DOOR OPENING OR CLOSING EVENT BASED ON MOBILE DEVICE SENSOR DATA”, which is incorporated herein by reference in its entirety.

### BACKGROUND

Many navigation, ride-hailing, ride-sharing and/or other location-based services rely on driver entries to determine passenger embarkment or dis-embarkment events and calculate fees accordingly. However, some drivers cheat on the services by not reporting or under-reporting rides. For instance, a driver accepted a trip request by a passenger, drove to the passenger's pickup location, and entered the trip request as cancelled while still drove to the destination of the passenger. To determine a passenger embarkment or dis-embarkment event, the services can detect a spike of the air pressure wave in the vehicle to determine the vehicle door opening/closing event. However, other vehicle events than a door opening/closing (such as an open window subject to an air pressure wave caused by a passing truck) can cause similar air pressure waves thus creating false positive detection of door opening/closing events. As a result, service providers face significant technical challenges to better detect vehicle door opening/closing events.

### SOME EXAMPLE EMBODIMENTS

Therefore, there is a need for an approach for accurately detecting a vehicle door opening or closing event based on mobile device sensor data, such as pressure sensor data collected during a vehicle idle/stop state.

According to one embodiment, a method comprises collecting sensor data from one or more sensors of a vehicle, a mobile device in the vehicle, or a combination thereof. The method also comprises determining a time period when the vehicle is in an idle state based on the sensor data. The method further comprises determining a vehicle door open event or a vehicle door close event based on pressure sensor data from at least one pressure sensor of the mobile device collected during the time period. The method further comprises providing the vehicle door open event or the vehicle door close event as an output.

According to another embodiment, an apparatus comprises at least one processor, and at least one memory including computer program code for one or more computer programs, the at least one memory and the computer program code configured to, with the at least one processor, cause, at least in part, the apparatus to collect sensor data from one or more sensors of a vehicle, a mobile device in the vehicle, or a combination thereof. The apparatus is also caused to determine a time period when the vehicle is in an idle state based on the sensor data. The apparatus is further caused to determine a vehicle door open event or a vehicle door close event based on pressure sensor data from at least one pressure sensor of the mobile device collected during the time period. The apparatus is further caused to provide the vehicle door open event or the vehicle door close event as an output.

According to another embodiment, a computer-readable storage medium carries one or more sequences of one or more instructions which, when executed by one or more processors, cause, at least in part, an apparatus to collect sensor data from one or more sensors of a vehicle, a mobile device in the vehicle, or a combination thereof. The apparatus is also caused to determine a time period when the vehicle is in an idle state based on the sensor data. The apparatus is further caused to determine a vehicle door open event or a vehicle door close event based on pressure sensor data from at least one pressure sensor of the mobile device collected during the time period. The apparatus is further caused to provide the vehicle door open event or the vehicle door close event as an output.

According to another embodiment, a computer program product may be provided. For example, a computer program product comprising instructions which, when the program is executed by a computer, cause the computer to collect sensor data from one or more sensors of a vehicle, a mobile device in the vehicle, or a combination thereof. The computer is also caused to determine a time period when the vehicle is in an idle state based on the sensor data. The computer is further caused to determine a vehicle door open event or a vehicle door close event based on pressure sensor data from at least one pressure sensor of the mobile device collected during the time period. The computer is further caused to provide the vehicle door open event or the vehicle door close event as an output.

According to another embodiment, an apparatus comprises means for collecting sensor data from one or more sensors of a vehicle, a mobile device in the vehicle, or a combination thereof. The apparatus also comprises means for determining a time period when the vehicle is in an idle state based on the sensor data. The apparatus further comprises means for determining a vehicle door open event or a vehicle door close event based on pressure sensor data from at least one pressure sensor of the mobile device collected during the time period. The apparatus further comprises means for providing the vehicle door open event or the vehicle door close event as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive. In particular, “speed” and “velocity” are used and can be used interchangeably along this manuscript.

### BRIEF DESCRIPTION OF THE DRAWINGS

The embodiments of the invention are illustrated by way of example, and not by way of limitation, in the figures of the accompanying drawings:

FIG. 1 is a diagram of a system capable of detecting a vehicle door opening or closing event based on mobile device sensor data, according to one embodiment;

FIG. 2A illustrating an example pressure profile of a vehicle, according to one embodiment;

FIG. 2B illustrating an example pressure/acceleration profile of a vehicle, according to one embodiment;

FIG. 2C illustrating an example acceleration profile and an example pressure profile of a vehicle, according to one embodiment;

FIG. 2D illustrating an example rotation profile and an example magnetic field profile of a vehicle, according to one embodiment;

FIG. 2E depict example frames of reference for determining vehicle events, according to one embodiment;

FIG. 3 is a diagram of a vehicle event module/vehicle event platform capable of detecting a vehicle door opening or closing event based on sensor data collected during a vehicle idle/stop state, according to one embodiment;

FIG. 4 is a flowchart of a process for detecting a vehicle door opening or closing event based on sensor data collected during a vehicle idle/stop state, according to one embodiment;

FIG. 5A is a diagram of a user interface associated with vehicle door closing/opening events, according to one embodiment;

FIG. 5B is a diagram of an example user interface showing a passenger pick-up event, according to one embodiment;

FIG. 6 is a diagram of a geographic database, according to one embodiment;

FIG. 7 is a diagram of hardware that can be used to implement an embodiment;

FIG. 8 is a diagram of a chip set that can be used to implement an embodiment; and

FIG. 9 is a diagram of a mobile terminal that can be used to implement an embodiment.

### DESCRIPTION OF SOME EMBODIMENTS

Examples of a method, apparatus, and computer program for determining vehicle information (e.g., speed, idle state, vehicle door opening or closing events, etc.) are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent or similar arrangement. In other instances, well-known structures and devices are shown in block diagram form in order to avoid unnecessarily obscuring the embodiments of the invention.

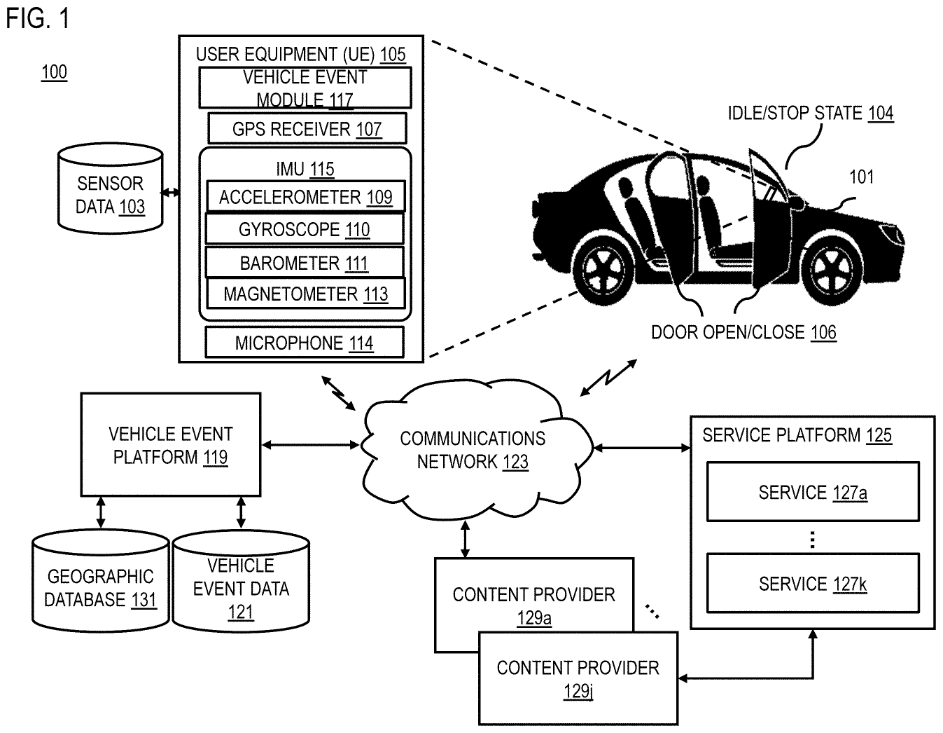

FIG. 1 is a diagram of a system capable of detecting a vehicle door opening or closing event based on mobile device sensor data (e.g., air pressure sensor data), according to one embodiment. The challenge is to automatically and correctly identify events of opening and closing of a door of a vehicle (OCD), regardless of other vehicle events exhibiting similar sensor profiles (e.g., a spike of the air pressure wave in the vehicle). Such OCD identification can be used, e.g., by a dispatcher for which the driver is a subcontractor or employee thereof to verify passenger embarkment or disembarkment for sake of billing, fraud detection/prevention, etc.

To address the technical challenges related to determining a vehicle door opening or closing event and minimize false OCD detection, the system 100 of FIG. 1 introduces a capability to detect a vehicle door opening or closing event based on sensor data collected during an idle/stop state of a vehicle 101.

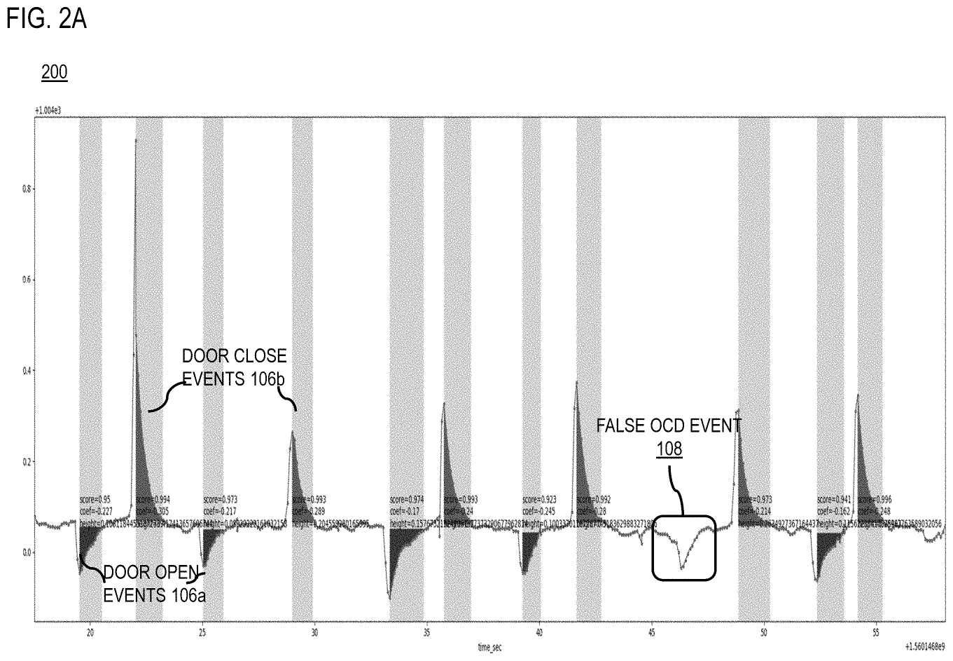

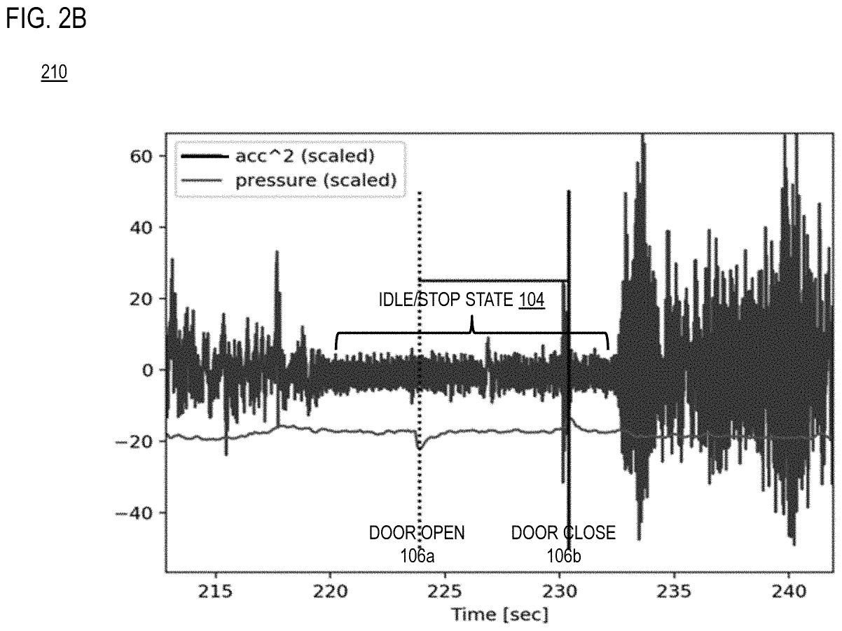

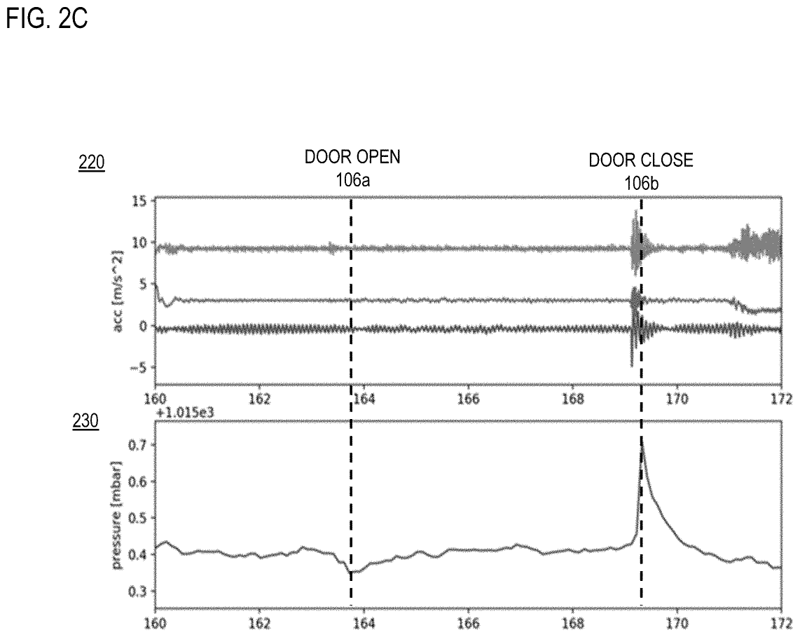

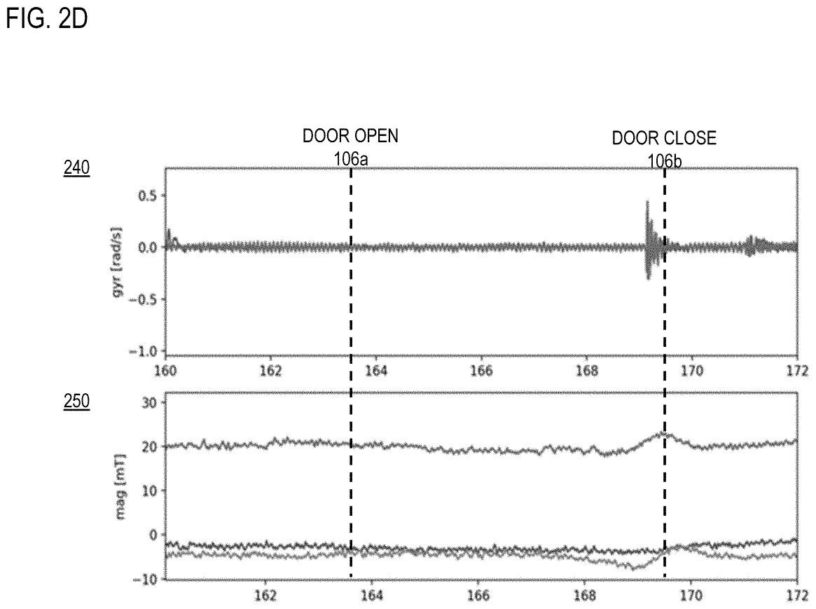

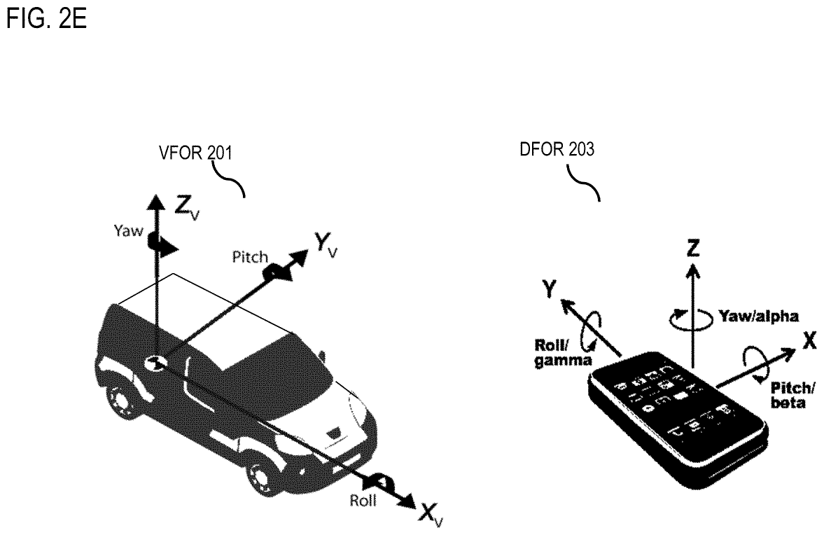

FIG. 2A illustrating an example pressure profile 200 of a vehicle, according to one embodiment. The pressure profile 200 shows a sequence of events of opening and closing of a door (OCD) of a vehicle (e.g., a 4-door passenger vehicle) along a timeline (e.g., in unit of second to ˜60 seconds) during a ride. Each gray section represents a door/opening/closing event of the vehicle 101 during the ride. The air pressure (e.g., in reference to the ambient pressure at sea level ˜+1.004e3 mbar) within the vehicle drops when a door is opening (corresponding to a door open event 106a) while the air pressure spikes up when a door is closing (corresponding to a door close event 106b). A moving/idle vehicle can maintain a positive air pressure due to air conditioning, circulating in external air, cracking a window open, etc. A moving/idle vehicle can maintain a negative air pressure due to circulating air out, closing windows, etc. However, not all drops/spikes are OCD events. For instance, a false OCD event 108 (e.g., a false door open event) can be caused by fully opening a window, etc. In this case, the system 100 can incorporate other mechanisms and/or sensor data to filter out false OCD events.

Usually, OCD events occur while the vehicle is not in motion. A typical sequence of events can be: (optional) Vehicle in motion→Vehicle stops→Door open→Potential Misc. Events→door closes→Vehicle in motion. As such, in one embodiment, the system 100 can use a vehicle idle/stop state as the most reasonable time period/window for a vehicle door opening or closing event to occur. The system 100 can obtain the sensors data during time segments/windows when the vehicle is idle/stops, thereby filtering out false OCD events. Using such detection windows greatly enhances the quality of the OCD detection since the signal to noise ratio (SNR) is much higher, and the rate of false positives/negatives becomes very low. Within such detection window(s), OCD events have unique signatures based on different types of sensor data.

In one embodiment, the system 100 can proceed with two layers: a data layer and an event layer. A first layer (the “data layer”) can be generated by collecting data from sensors of the vehicles 101 and/or a user equipment (UE) device 105 (e.g., a driver's smart phone) in the vehicle 101, thereby processing the collected data for different types of sensors. A second layer (the “event layer”) can include an algorithm that integrates data from one or more of the sensors in the first layer into a decision whether a certain event (e.g., a vehicle idle/stop event, a vehicle door opening or closing event, etc.) took place. In addition, the system 100 can use the sensor data 103 to build and/or train a machine learning model, i.e., a vehicle door opening/closing decision model (such as “rule based” or “probabilistic”) to detect and/or infer the vehicle door opening or closing event.

In the data layer, the sensor data 103 can be collected from one or more location sensors (e.g., a GPS receiver 107), one or more acceleration sensors (e.g., an accelerometer 109), one or more gyroscopes (e.g., a gyroscope 110), one or more atmospheric pressure meters (e.g., a barometer 111), one or more magnetic field meters (e.g., a magnetometer 113), one or more microphones (e.g., a microphone 114), etc.

In the event layer, in one embodiment, the system 100 can determine an idle/stop state 104 of the vehicle 101 based on the sensor data 103, and then detect a vehicle door opening/closing event 106 during the idle/stop state 104, to minimize false detection of door opening/closing events. For instance, the system 100 can determine an idle/stop state 104 of the vehicle 101 based on location sensor data that shows the vehicle 101 not in motion, but not whether the vehicle 101 is idle or stopped (i.e., engine off). Idling refers to running a vehicle's engine when the vehicle is not in motion, such as waiting for a passenger, a traffic light, etc. On the other hand, the system 100 can detect vehicle idle/stop states via engine sensor data: a vehicle stop with its engine off, a vehicle idle with its engine on, etc. In another embodiment, the system 100 can detect vehicle idle/stop states based on accelerometer and/or gyroscope data by determining vibrations cause by a vehicle engine (e.g., an internal combustion engine), thereby determining idle states of the vehicle (e.g., idle=time-independent engine vibration).

In another embodiment, the system 100 can detect vehicle idle/stop states based on vehicle speed data that is measured using a frequency response of the magnetic field in the vehicle, thereby determining idle/stop states of the vehicle (e.g., idle/stop=speed zero). The system 100 can detect a vehicle speed using a frequency response of the magnetic field in the vehicle, since magnetometer is sensitive to changes in the magnetic field and the vehicle tires in most cases are steel-belted radial tires that tend to be magnetized. The net effect is that tires behave as rotating magnets such that the tire rotation frequency (related to speed) can be measured with the magnetometer.

In another embodiment, the system 100 can detect vehicle idle/stop states based on sensitive pressure sensors data (e.g., to detect several cm of height change), thereby determining idle/stop states of the vehicle (e.g., idle/stop=zero pressure gradient). In addition, a barometric pressure spike in a pressure profile of the vehicle can be a sign of the vehicle door open/close that usually occurs after a vehicle is idle/stopped.

In one embodiment, the system 100 can apply multiple independent sensors/algorithms for detecting an idle state, for example, for redundancy in case when some sensors are missing or malfunctioning. For instance, the system 100 can apply one or more idle estimation algorithms on overlapping time windows (e.g., of 4-5 seconds) for online detection of an idle/stop state. Such algorithms for calculating a local estimate of an idle state per window can include (1) standard deviation of accelerometer magnitude or energy, (2) standard deviation of gyroscope magnitude or energy, (3) spectral content of accelerometer and/or gyroscope, (4) speed based on magnetic field measurements, (5) variations and spikes in magnetic fields during engine ignition, (6) GPS/GNSS based location and speed information, (7) standard deviation of barometric pressure and/or pressure gradient, (8) a machine learning/AI classifier based on the above idle estimation algorithms and optionally using raw sensors data for training, etc.

After determining an idle/stop state 104 of the vehicle 101 as above, the system 100 can proceed to detect OCD events 106 during the idle/stop state 104. By way of example, a barometer can measure the air pressure nearby the UE 105 (e.g., the driver's smart phone) at the occurrence of OCD events (e.g., sharp pressure changes as in the pressure profile 200 of FIG. 2A). The OCD events can be characterized as close or open by a fast pressure change (positive or negative) followed by a slower decay. The air pressure decay process in the vehicle can be modelled as an exponential first order process

$$Δ P ( t ) = Δ {P}_{0} exp ( - \frac{t}{τ} ) ,$$

with a time constant τ=V/(A\sqrt{RT}) with R being the ideal gas constant divided by the molecular weight, V is the effective internal volume of the vehicle and A is the effective leakage area. T is the temperature (in Kelvin).

To obtain an exponential relationship for pressure change as a function of time, the system 100 can apply the ideal gas law:

$$\frac{dP}{dt} = R T \frac{d ρ}{dt} \qquad ( 1 )$$

where, dp/dt is a pressure rate change, dρ/dt is a density rate change, R is an ideal gas constant divided by a molecular weight of the gas, and T is the absolute temperature (in Kelvin), assumed to be constant during OCD events.

The density as a function of time, rho(t), can be restated as a function of the leak rate:

$$ρ = \frac{M}{V} \qquad ( 2 )$$

$$\frac{d ρ}{dt} = \frac{1}{V} \frac{dM}{dt} \qquad ( 3 )$$

the mass rate of change dm/dt is simply the mass flow rate through the leak:

$$\frac{dM}{dt} = - ρ ( t ) \cdot A \cdot u \qquad ( 4 )$$

where, ρ(t) is a gas density at time t, A is an effective leak area, and u is an average velocity of gas molecules.

The system 100 can combine Equations 3 and 4:

$$\frac{d ρ}{dt} = - \frac{A u}{V} ρ ( t ) \qquad ( 5 )$$

The negative sign is included because gas is leaving the vehicle and the density is decreasing as a function of time.

In thermal equilibrium, gas velocity is:

u=\sqrt{RT} (6)

Assuming (again) the ideal gas relation ρ=P/(RT) and combining Eq. 1, 5 and 6, the system 100 finally obtains:

$$\frac{dP}{dt} = - \frac{A \sqrt{R T}}{V} P ( t ) \qquad ( 7 )$$

which integrates to:

$$P ( t ) = {P}_{0} \cdot exp ( - \frac{t}{τ} ) \qquad ( 8 )$$

where P₀ is an initial gas pressure,

$$τ = \frac{V}{A \sqrt{R T}}$$

is a pressure decay time constant.

Since parameters affecting vehicle air pressure (e.g., a vehicle internal volume, effective leakage area(s), etc.) are to some extent characteristics of a given vehicle model and manufacturing choices, these parameters could be learned over time for determining baseline pressure profile(s) of the vehicle to be used as a filter to identify true OCD events. The model for the decay time can consider that small vehicles exhibit faster pressure decay compared to large vehicles (assuming similar leakage area(s)). In addition, the initial pressure spike would tend to be higher in small vehicles, since the door size is generally similar in all vehicles, while the relative air intake/outtake as a result of OCD events is larger in small vehicles, in proportion to their volumes. Once detected, the system 100 can determine whether it is a door opening or closing event based on the polarity of the pressure signal. A door open event leads to a pressure drop in the cabin of the vehicle, while a door close event leads to over pressure in the cabin.

The above-discussed pressure-based OCD detection utilizes a specific/distinctive signature of the pressure profile (e.g., in FIG. 2A), since other sensor responses to OCD events do not lead to the same profile (e.g., a fast/sharp rise followed by a slower, exponential decay). The system 100 can pair sensitive pressure sensor(s) with any threshold detector for detecting the fast/sharp rise and/or the slower, exponential decay.

In a noisy environment (e.g., a low quality pressure sensor, leaky windows, etc.), the system 100 can use the pressure profile as the basis to build a convolution filter, to further improve the SNR. The convolution filter is initially built based on expected typical pressure profile, yet over time, the system 100 can apply machine learning to learn a pressure decay rate parameter (τ) for specific vehicles/users (this improves over time).

FIG. 2B illustrating an example pressure/acceleration profile 210 of a vehicle, according to one embodiment. The example pressure/acceleration profile in FIG. 2B combines an accelerometer graph of wave packet(s) (in squared magnitude) and a pressure profile during OCD events. The acceleration graph depicts magnitude square values (“acc\hat{ }2”, energy) of a portion (˜215-240 seconds) of a ride, e.g., as measured by an accelerometer of the UE 105. A pressure line of the pressure profile lays underneath the acceleration graph during the portion of the ride. While idle, the pressure line is roughly constant. While in motion, the pressure line reflects pressure/height variations along the ride.

The accelerometer can measure an acceleration of the UE 105 as a voltage. The accelerometer graph shows a drop in the acceleration variance (e.g., standard deviation) during the idle/stop state 104. The system 100 can then detect OCD events within the idle/stop state 104, where a door open event 106a as a drop in the pressure file and a door close event 106b as a spike thereof. In FIG. 2B, a vertical broken line marks a door open event 106a, which a vertical solid line marks a door close event 106b. The door open event 106a created a minute variation/change in the accelerometer graph, while the door close event 106b caused a significant spike. A small spike inbetween the OCD events 106a, 106b corresponds to a passenger entering the vehicle (e.g., a false OCD event 108).

In addition, accelerometer data (i.e., magnitudes of accelerations (“acc”), m/s\hat{ }2) can indicate an OCD event by itself, due to the mechanical impact that is caused by a door movement. FIG. 2C illustrating an example acceleration profile 220 and an example pressure profile 230 of a vehicle of a portion (˜160-172 seconds) of a ride, according to one embodiment. The acceleration profile 220 shows a small acceleration peak near a door open event 106a (corresponding to an air pressure drop in the pressure profile 230), and a large acceleration peak near a door close event 106b (corresponding to an air pressure spike in the pressure profile 230) along the x, y, or z axis of the vehicle.

In other embodiments, the system 100 can use or incorporate other sensors (gyroscopes magnetometers, microphones, etc., to detect OCD events. FIG. 2D illustrating an example rotation profile 240 and an example magnetic field profile 250 of a vehicle of a portion (˜160-172 seconds) of a ride, according to one embodiment. A gyroscope can be another sensitive sensor that detects mechanical movements (e.g., rotations, rad/s). In one embodiment, the system 100 can use the gyroscope to detect a mechanical signature of OCD events. For instance, the rotation profile 240 shows a door close event 106b near second 169 as a peak/wave packet of the gyroscope data (x, y, and z-rotations).

Within the detection window (e.g., the idle/stop state 104)), OCD events are marked by the rise of a localized wave packet in the acceleration profile 220 and the rotation profile 240. Door open events (e.g., the door open event 106a) are mild events that are barely above a noise level, while door close events (e.g., the door close event 106b) are obvious. Both types of events are observable but are not very specific with respect to false OCD events (e.g., a passenger exit/enter event). Passengers coming in and out can also generate similar responses and so do accidental movements of the UE 105 itself (e.g., accidental touches by a user). The system 100 can threshold detector(s) on these responses in the profiles to detect OCD events and corroborate the pressure sensor reading.

Once a wave packet is validated as an OCD event, the system 100 can extract additional information. For instance, in another embodiment to be explained in detail later, when rotating the converting the sensor data from a device frame of reference to a vehicle frame of reference, OCD events exhibit responses on particular axes (e.g., yaw angle rotations and y-axis acceleration), which can make the responses in the acceleration/rotation profiles more unique.

In another embodiment, the system 100 can use a magnetometer to detect OCD events since opening/closing a door will move a large metallic object (i.e., the door) that influences over the magnetic field (mt) within the vehicle. OCD events may lead to temporal changes in the local magnetic field next to the UE 105. These effects are more significant during the door close event (e.g., associated with the door closing speed). These effects, when observed, are unique to the OCD event. Although the system 100 cannot exclude an external transient magnetic source, such external events are rather rare thus neglectable. OCD detection can be done via any threshold detector on the original signal or on the signal derivative(s) after applying appropriate low-pass filter(s). For instance, the magnetic field profile 250 shows a clear signature of the door close event 106b near second 169 when the magnetic field is being altered along the x, y, or z axis of the vehicle.

In another embodiment, the system 100 can use a microphone to detect OCD events, since OCD events have signature sounds to be captured by the microphone that can be calibrated and adapted per vehicle. Door close events have a unique sound signature resulting from the mechanical impact on the vehicle. These signatures can be discovered and learned over time, by combining the labeling from other sensors, like the pressure sensor(s). Once trained, the system 100 can use ML based models for sound-based OCD detection.

Alternatively or concurrently, the system 100 can use the microphone to capture (1) surrounding noise which is larger when a door is open and smaller when a door is close, and/or (2) background music in the vehicle is larger when a door is close and smaller when a door is open, as surrogate data for OCD event identification. When opening/closing doors, there is a change in background music and/or surrounding noise level. For instance, in a busy rush hour, much of the external noise is filtered out while the doors are closed. Once opened, the noise level goes up significantly. In another scenario, driving with laud music inside. When opening a door, the sound pressure level drops because some of the reverberations are eliminated as music spills outside.

In another embodiment, the system 100 can use location data (e.g., GPS, cellular, Wi-Fi, and/or BT data), to detect a vehicle idle/stop state, which can be surrogate data for detecting an OCD event.

Given one or more types of the above-referenced sensor data, the system 100 can construct an algorithm to detect/identify OCD events. Such algorithm can be based on rules, thresholds, probabilities, classifications, etc. By way of example, an identification of OCD events can be done using a rule-based algorithm taking into account idle/stop detection by the accelerometer profile, and wave packet detection of the pressure profile as in FIG. 2B. The vertical solid line and the vertical broken line can be the outputs of the algorithm.

As discussed, OCD events can be observed in the accelerometer and gyroscope profiles. In another embodiment, the system 100 can further determine OCD event characteristic, such as opening/closing a left or right side door, based on an angular momentum response of the gyroscope and a linear momentum response of the accelerometer to an OCD event.

When closing a door, the vehicle experiences a collision event between the door and the vehicle frame. FIG. 2E depict example frames of reference for determining vehicle events, according to one embodiment. In FIG. 2E, a vehicle frame of reference (VFOR) 201 has axes Xv, Yv, and Zv, while a device frame of reference (DFOR) 203 has axes X, Y, and Z. The system 100 can assume the UE 105 as stationary with respect to the vehicle 101, then calculate the rotation matrix R between DFOR and VFOR, i.e., the rotation matrix R calibrating vectors from DFOR 203 to VFOR 201. When the UE 105 moves to a different position and/or orientation in the vehicle 101, the system 100 can re-calculate the rotation matrix R accordingly.

Regarding the angular momentum response (gyroscope), some of the angular momentum of the opening/closing door is transferred to the vehicle frame, forcing the angular momentum into vibrations that quickly decay. For instance, closing the door on the left side of the vehicle (i.e., the driver side in western Europe and the US) will result in an initial yaw rotation of the vehicle frame in the positive yaw rotation angle. Similarly, door closed on the right-hand side will result in an initial yaw rotation in the negative yaw rotation angle. Door opening results in similar effects, but of smaller magnitudes. When opening a door on the left side, due to angular momentum conservation, the vehicle frame is initially pushed in the direction of the positive yaw rotation angle, and vice versa on the right side. The effect of door open events (e.g., vibrations) on the vehicle frame, however, is much smaller compared to door close events, since door opening is a gentler operation involving smaller forces and angular momentum.

Regarding linear momentum response (accelerometer), closing the door generates a collision with the vehicle frame, such as forces that can be detected by the accelerometer. When closing the door on the left side, the system 100 can observe an initial spike in the negative y-axis which oscillates and then decays to zero. Similarly, when closing a door on the right side, 100 can observe an initial spike in the positive y-direction. Door opening results in similar oscillations, but of a smaller magnitude. When opening a door on the left side, due to linear momentum conservation, the vehicle frame is initially pushed in the direction of the negative y-axis, and vice versa on the right side. The effect, however, is much smaller compared to door close events, since door opening is a gentler operation involving smaller forces and linear momentum.

By way of example, when the UE 105 is placed in a holder in a predetermined orientation relative to the vehicle (e.g., the y-axis of the phone coincides with the z-axis of the vehicle), the corresponding angular component as measured on the UE 105 can be translated to the vehicle yaw response and thus the system 100 can detect the side of the OCD event based on the polarity (sign) of the initial yaw angle.

In general, the UE 105 can be in an unknown arbitrary orientation relative to the vehicle. The system 100 can determine the rotation matrix R between the DFOR 203 and the VFOR 201. With the rotation matrix R, the system 100 no longer requires a predetermined device orientation, and just uses the rotation matrix R to convert gyroscope data from the UE 105 to the VFOR 201, and then the vehicle yaw angle sign and dynamics become available to determine OCD event characteristic, such as opening/closing a left or right side door.

In short, the system 100 can detect both door open events and door close events. In addition, the system 100 can characterize the OCD event as close or open, through a pressure decay rate parameter. The system can provide the door opening/closing information of the vehicle to various service providers, such as taxi services, ride hailing services, ride sharing services, fleet management services, etc., about the actual state of a vehicle and/or behaviors of a driver that is under their auspices. For instance, the system 100 can validate the beginning or end of a ride, to locate the accurate pick up and drop off of a passenger, and detect or prevent fraudulent behaviors by drivers that may consider to conceal actual data from the service providers. The information also assists in knowing the status of driver availability from the level of a single driver to an entire fleet, thereby optimizing ride bids, workload, shift planning, etc.

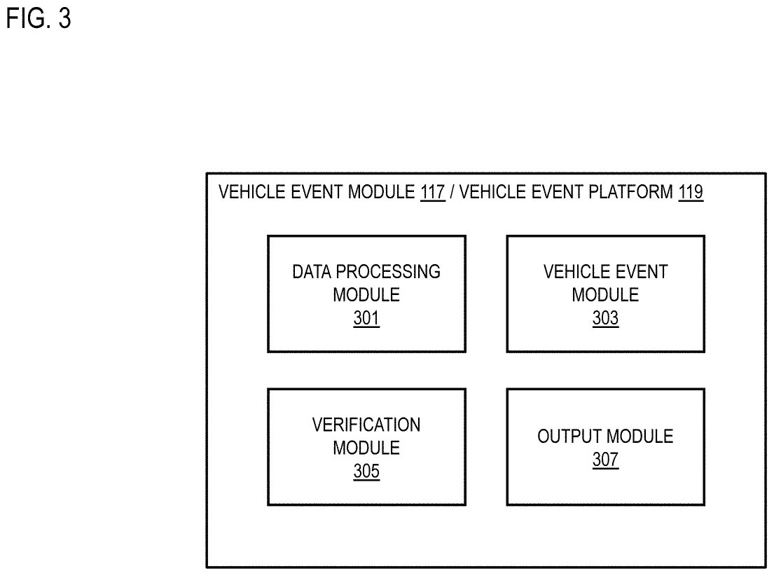

FIG. 3 is a diagram of a vehicle event module/vehicle event platform capable of detecting a vehicle door opening or closing event based on sensor data collected during a vehicle idle/stop state, according to one embodiment. In one embodiment, a vehicle event module 117 (e.g., a local component) and/or a vehicle event platform 119 (e.g., a network/cloud component) may perform one or more functions or processes associated with detecting a vehicle door opening or closing event based on sensor data collected during a vehicle idle/stop state (e.g., from the barometer 111 or equivalent sensors). By way of example, as shown in FIG. 3, the vehicle event module 117 and/or vehicle event platform 119 include one or more components for performing functions or processes of the various embodiments described herein. It is contemplated that the functions of these components may be combined or performed by other components of equivalent functionality. In one embodiment, the vehicle event module 117 and/or vehicle event platform 119 include a data processing module 301, a vehicle event module 303, a verification module 305, and an output module 307. The above presented modules and components of the vehicle event module 117 and/or vehicle event platform 119 can be implemented in hardware, firmware, software, or a combination thereof. In one embodiment, the vehicle event module 117, vehicle event platform 119, and/or any of their modules 301-307 may be implemented as a cloud-based service, local service, native application, or combination thereof. The functions of vehicle event module 117, vehicle event platform 119, and modules 301-307 are discussed with respect to FIGS. 3-5 below. For instance, the vehicle event module 303 can work in conjunction with the verification module 305 to detect a vehicle idle state (e.g., in motion, idle with engine on, stopped with engine off), a turning event, a lane change, a direction of motion (e.g., forward or reverse drive), a door open/close, etc. using the following processes.

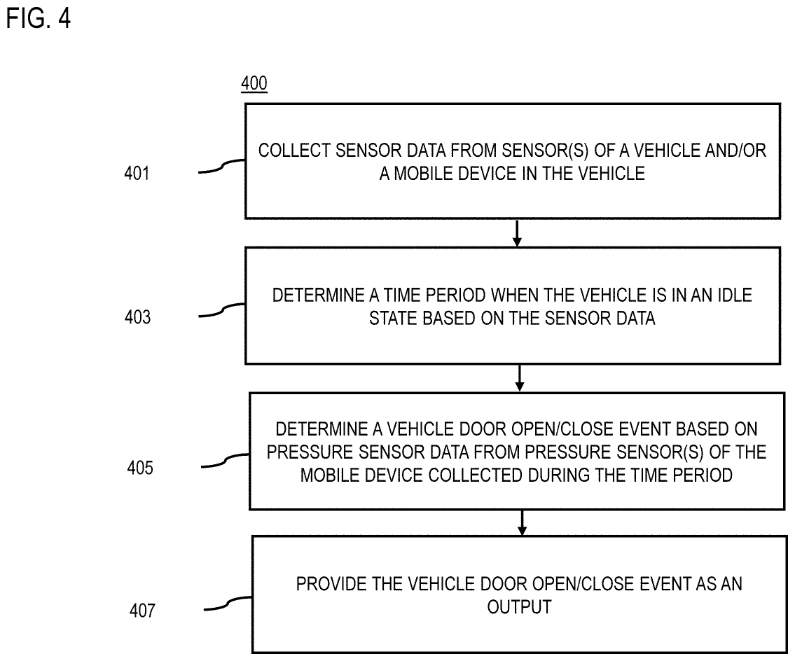

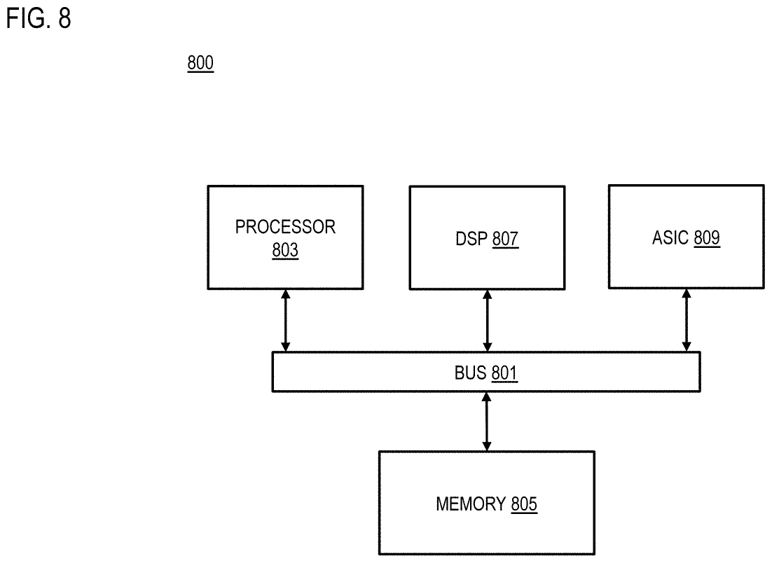

FIG. 4 is a flowchart of a process for detecting a vehicle door opening or closing event based on sensor data collected during a vehicle idle/stop state, according to one embodiment. In various embodiments, the vehicle event module 117, vehicle event platform 119, and/or any of their modules 301-307 may perform one or more portions of the process 400 and may be implemented in, for instance, a chip set including a processor and a memory as shown in FIG. 8. As such, the vehicle event module 117, vehicle event platform 119, and/or any of their modules 301-307 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all the illustrated steps.

In one embodiment, the process 400 can provide a practical approach for detecting a vehicle door opening or closing event based on sensor data collected during a vehicle idle/stop state using the sensors of the UE 105, taking advantage of an idle/stop state of the vehicle 101.

In one embodiment, in step 401, the data processing module 301 can collect sensor data (e.g., the sensor data 103) from one or more sensors of a vehicle (e.g., the vehicle 101), a mobile device (e.g., the UE 105) in the vehicle, or a combination thereof.

In one embodiment, in step 403, the vehicle event module 303 can determine a time period (e.g., the detection window) when the vehicle is in an idle state (e.g., the idle/stop state 104) based on the sensor data.

In one embodiment, in step 405, the vehicle event module 303 can determine a vehicle door open event (e.g., the vehicle door close event 106a in FIGS. 2B-2D) or a vehicle door close event (e.g., a vehicle door close event 106b in FIGS. 2B-2D) based on pressure sensor data from at least one pressure sensor (e.g., the barometer 111) of the mobile device collected during the time period (e.g., the detection window). For instances, the vehicle door open event or the vehicle door close event can be based on determining that the pressure sensor data indicates that an air pressure change is greater than a pressure change threshold. By way of example, an air pressure change for the vehicle door open event is detected as a negative pressure change (e.g., in the pressure profile 200 in FIG. 2A), and an air pressure change for the vehicle door close event is a positive pressure change (e.g., in the pressure profile 200 in FIG. 2A).

In another embodiment, the vehicle event module 303 can generate a pressure change profile (e.g., FIG. 2A) indicating the air pressure change based on the pressure sensor data, and determine one or more pressure decay rates (e.g., the pressure decay rate parameter (T) for specific vehicles/users) from the pressure change profile. For instance, collecting of the pressure sensor data is initiated by determining that the vehicle is in an idle state.

By way of example, the vehicle door open event or the vehicle door close event can be determined based on comparing the pressure change profile (FIG. 2C) to a reference pressure profile (e.g., FIG. 2A), comparing the one or more pressure decay rates to a reference pressure decay rate, or a combination thereof. In one embodiment, the reference pressure profile, the reference pressure decay rate, or a combination thereof can be selected by the vehicle event module 303 based on a type of the vehicle (e.g., of different models by different manufacturers, etc.), a user of the vehicle (e.g., users closing doors differently), or a combination thereof.

In one embodiment, the vehicle event module 303 can train a machine learning model (e.g., an OCD machine learning model) to identify the vehicle door open event or the vehicle door close event based on the pressure sensor data, the sensor data, or a combination thereof. In another embodiment, the vehicle event module 303 can train a driver cheating machine learning model to identify driver cheating behaviors (e.g., under-reporting rides) based on the vehicle door open event or the vehicle door close event data.

In one embodiment, the vehicle event module 303 in connection with a machine learning system can selects respective factors such as sensor data, map data, driving behaviors, vehicle state data, transport modes, ride hailing data, ride sharing data, traffic patterns, road topology, etc., to determine the machine learning models. In one embodiment, the vehicle event module 303 can train the machine learning system to select or assign respective weights, correlations, relationships, etc. among the factors, to determine machine learning models for different vehicle(s)/fleets, etc. In one instance, the machine learning system can continuously provide and/or update the machine learning models (e.g., a support vector machine (SVM), neural network, decision tree, etc.) during training using, for instance, supervised deep convolution networks or equivalents. In other words, the machine learning system can train the machine learning models using the respective weights of the factors to most efficiently select optimal factors/weightings for different scenarios in different regions.

In another embodiment, the machine learning system includes a neural network or other system to compare (e.g., iteratively) driver behavior patters, vehicle paths features, etc.) to detect OCDs, and/or driver cheating events. In one embodiment, the neural network of the machine learning system is a traditional convolutional neural network which consists of multiple layers of collections of one or more neurons (which are configured to process a portion of an input data). In one embodiment, the machine learning system also has connectivity or access over the communication network 123 to the vehicle event database 121 and/or the geographic database 123.

In one embodiment, the vehicle event module 303 can improve the process 400 using feedback loops based on, for example, user behavior and/or feedback data (e.g., from passengers). In one embodiment, the vehicle event module 303 can improve the machine learning models using user behavior and/or feedback data as training data. For example, the vehicle event module 303 can analyze correctly identified OCD/cheating event data, missed OCD/cheating event data, etc. to determine the performance of the machine learning models.

In one embodiment, in step 407, the output module 307 can provide the vehicle door open event or the vehicle door close event as an output. In one embodiment, the output module 307 can determine a user embarkment or dis-embarkment event associated with the vehicle based on the vehicle door open event or the vehicle door close event. In other embodiment, the output module 307 can process the output to perform at least one of: (1) mapping a pickup or drop off area in a digital map, a database, or a combination thereof, (2) providing navigation routing data to the vehicle, the user, or a combination thereof, (3) fleet management, and (4) vehicle dispatch.

In one embodiment, the verification module 305 can process the sensor data to detect one or more indications of the vehicle door open event or the vehicle door close event detected from the pressure sensor data, and verify the vehicle door close event or the vehicle door open event based on the one or more indications. As such, the output can be provided based on the verifying.

By way of example, the vehicle event module 303 can determine a duration of a drop in accelerometer data variances over the timeline (e.g., FIG. 2B) as the idle state. The vehicle event module 303 can determine a spike in the accelerometer data variances within the detection window exceeding a first threshold (e.g., a small acceleration peak near the open door event in FIG. 2B) as a vehicle door open event. The vehicle event module 303 can determine a spike in the accelerometer data variances within the detection window exceeding a second threshold (e.g., a large acceleration peak near the close door event in FIG. 2B) as a vehicle door close event, while the second threshold is larger than the first threshold.

Then after, the verification module 305 can verify the OCD event using other sensor data. For instance, the verification module 305 can determine a spike in gyroscope data within the detection window exceeding a third threshold as a vehicle door close event (e.g., the close-door event near second 169 is clearly seen as a peak/wave packet of the gyroscope data in the rotation profile 240 in FIG. 2D). The verification module 305 can determine a spike in magnetometer data within the detection window exceeding a fourth threshold as a vehicle door close event (e.g., a clear signature of the “close door” event by the magnetic field profile 250 in FIG. 2D). The verification module 305 can determine one or more sound patterns of a vehicle door open or close event. The verification module 305can determine an increase in surrounding sound data within the detection window exceeding a fifth threshold as a vehicle door open event, and a decrease in surrounding sound data within the detection window exceeding a sixth threshold as a vehicle door close event.

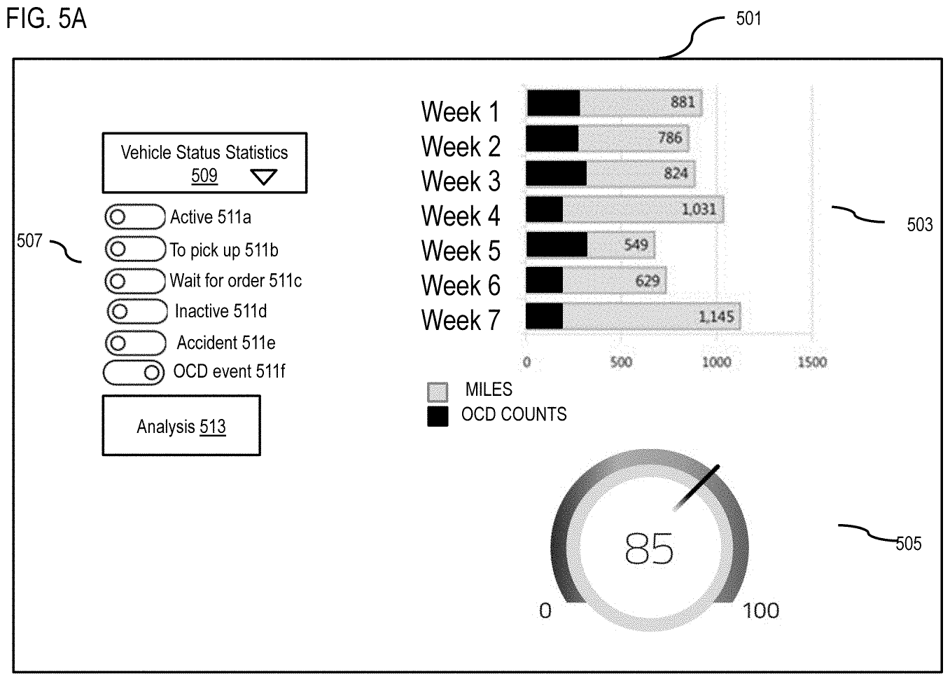

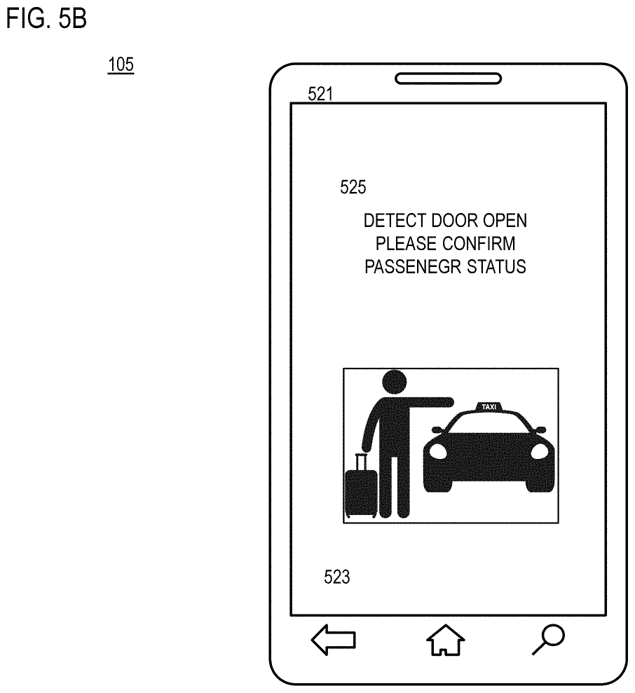

In one embodiment, the output module 307 can present/visualize vehicle door closing/opening events of a vehicle on a user interface. FIG. 5A is a diagram of a user interface associated with vehicle door closing/opening events, according to one embodiment. In this example, the UI 501 shown may be generated for a UE 105 (e.g., a mobile device, an embedded navigation system of the vehicle 101, a server of a vehicle fleet operator, a server of a vehicle insurer, etc.) that depicts a bar chart 503 and a driver cheating scale 505. For instance, the bar chart 503 shows weekly mileages and detected OCD counts of the vehicle (e.g., a ride hailing vehicle), while the driver cheating scale 505 shows a probability that the driver of the ride hailing vehicle cheated.

The UI 501 further shows a display setting panel 507 that includes a setting dropdown menu 509, a plurality of vehicle state statistics switches 511, and an input 513 of “Analysis.” By way of example, the state statistics switches 511 included Active 511a, To pick up 511b, Wait for order 511c, Inactive 511d, Accident 511e, OCD event 511f, etc.

By way of example, the OCD event 511f is switched on by a user (e.g., a driver, a passenger, a vehicle fleet management personnel, a vehicle insurance personnel, etc. with different levels of data access based on credentials), and the user further selects the input 513 of “Analysis”. The user can be a human and/or artificial intelligence. Fleet management can go beyond vehicle dispatch to include purchasing and maintaining vehicles, registering and licensing vehicles, cutting costs and maximizing profits, etc. As a result, the system 100 analyzes the weekly mileages as being disproportion with the OCD counts of the ride hailing vehicle using the above-discussed embodiments, calculates the driver cheating score as 85, and displays the score in the driver cheating scale 505.

Subsequently, the system 100 can monitor the driver's driving behaviors and/or OCD events based on the sensor data 103, and sends alerts to the driver upon detecting a passenger pick-up event and/or suspicious behaviors. FIG. 5B is a diagram of an example user interface showing a passenger pick-up event, according to one embodiment. In this example, a UI 521 shown is generated for a UE 105 (e.g., a mobile device, an embedded navigation system, a client terminal, etc.) that includes a passenger pick-up event diagram 523. By way of example, the system 100 monitors the vehicle state as To pick up, and detects a vehicle idle/stop event and then a vehicle door close event. The system 100 can then an alert 525: “Detect door open. Please confirm passenger status,” as the reminder for the driver to enter the actual pick-up status.

In one embodiment, the system 100 can set different users with different access rights to different vehicle state statistics as well as different granular levels within each data feature. When the user selectively switches on the vehicle state statistics features, such the new driver 511f, the system 100 can factor in additional vehicle state statistics for the analysis.

In another embodiment, the system 100 may be configured to dynamically, in real-time, or substantially in real-time, adjust the alert based on driver behavior changes and display on the UI 501 accordingly. In yet another embodiment, the system 100 may be configured to dynamically, in real-time, or substantially in real-time, adjust the alert based on other contextual changes in weather, traffic, fuel costs, etc.

In other embodiments, the vehicle event data 121 can be provided by the output module 307 as an output over a communications network 123 to a service platform 125 including one or more services 127a-127k (also referred to as services 127). As discussed above, the services 127 can include, but are not limited to, mapping services, navigation services, ride-haling services, ride sharing services, parking services, vehicle insurance services, and/or the like that can combine the vehicle event data 121 with digital map data (e.g., a geographic database 131) to provide location-based services. It is also contemplated that the services 127 can include any service that uses the vehicle event data 121 to provide or perform any function. In one embodiment, the vehicle event data 121 can also be used by one or more content providers 129a-129j (also collectively referred to as content providers 129). These content providers 129 can aggregate and/or process the vehicle event data 121 to provide the processed data to its users such as the service platform 125 and/or services 127. The sensor data 103 and/or the vehicle event data 121 cab be stored in a stand-alone database, or a geographic database 131 that also stores map data.

Returning to FIG. 1, the system 100 comprises one or more vehicles 101 associated with one or more UEs 105 having respective vehicle event modules 117 and/or connectivity to the vehicle event platform 119. The UE 105 can be mounted to the dashboard or other fixed position within the vehicle 101 or carried by a driver/passenger of the vehicle 101. The sensors can be standalone sensors within the UE 105 or part of an IMU 115 within the UE 105. It is noted, however, that embodiments in which the sensors are included within the UE 105 are provided by way of illustration and not as a limitation. In other embodiments, it is contemplated that the sensors (e.g., the magnetometer 113 and/or accelerometer 109) may be mounted externally to the UE 105 (e.g., as a component of the vehicle 101 or other device within the vehicle 101). In addition, the vehicle event module 117 for calculating the distances or other parking characteristic/information of the vehicle 101 according to the embodiments described herein need not reside within the UE 105 and can also be included as a component of the vehicle 101 and/or any other device internal or external to the vehicle 101.

By way of example, the UEs 105 may be a personal navigation device (“PND”), a cellular telephone, a mobile phone, a personal digital assistant (“PDA”), a watch, a camera, a computer, an in-vehicle or embedded navigation system, and/or other device that is configured with multiple sensor types (e.g., accelerometers 109, magnetometers 113, etc.) that can be used for determined vehicle speed according to the embodiments described herein. It is contemplated, that the UE 105 (e.g., cellular telephone or other wireless communication device) may be interfaced with an on-board navigation system of an autonomous vehicle or physically connected to the vehicle 101 for serving as a navigation system. Also, the UEs 105 and/or vehicles 101 may be configured to access the communications network 123 by way of any known or still developing communication protocols. Via this communications network 123, the UEs 105 and/or vehicles 101 may transmit sensor data collected from IMU or equivalent sensors for facilitating vehicle speed calculations.

The UEs 105 and/or vehicles 101 may be configured with multiple sensors of different types for acquiring and/or generating sensor data according to the embodiments described herein. For example, sensors may be used as GPS or other positioning receivers for interacting with one or more location satellites to determine and track the current speed, position and location of a vehicle travelling along a roadway. In addition, the sensors may gather IMU data, NFC data, Bluetooth data, acoustic data, barometric data, tilt data (e.g., a degree of incline or decline of the vehicle during travel), motion data, light data, sound data, image data, weather data, temporal data and other data associated with the vehicle and/or UEs 105 thereof. Still further, the sensors may detect local or transient network and/or wireless signals, such as those transmitted by nearby devices during navigation of a vehicle along a roadway. This may include, for example, network routers configured within a premise (e.g., home or business), another UE 105 or vehicle 101 or a communicable traffic system (e.g., traffic lights, traffic cameras, traffic signals, digital signage).

By way of example, the vehicle event module 117 and/or vehicle event platform 119 may be implemented as a cloud-based service, hosted solution or the like for performing the above described functions. Alternatively, the vehicle event module 117 and/or vehicle event platform 119 may be directly integrated for processing data generated and/or provided by the service platform 125, one or more services 127, and/or content providers 129. Per this integration, the vehicle event platform 119 may perform client-side state computation of vehicle speed data.

By way of example, the communications network 123 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

A UE 105 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that a UE 105 can support any type of interface to the user (such as “wearable” circuitry, etc.).

By way of example, the UE 105s, the vehicle event module 117/vehicle event platform 119, the service platform 125, and the content providers 129 communicate with each other and other components of the communications network 123 using well known, new or still developing protocols. In this context, a protocol includes a set of rules defining how the network nodes within the communications network 123 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

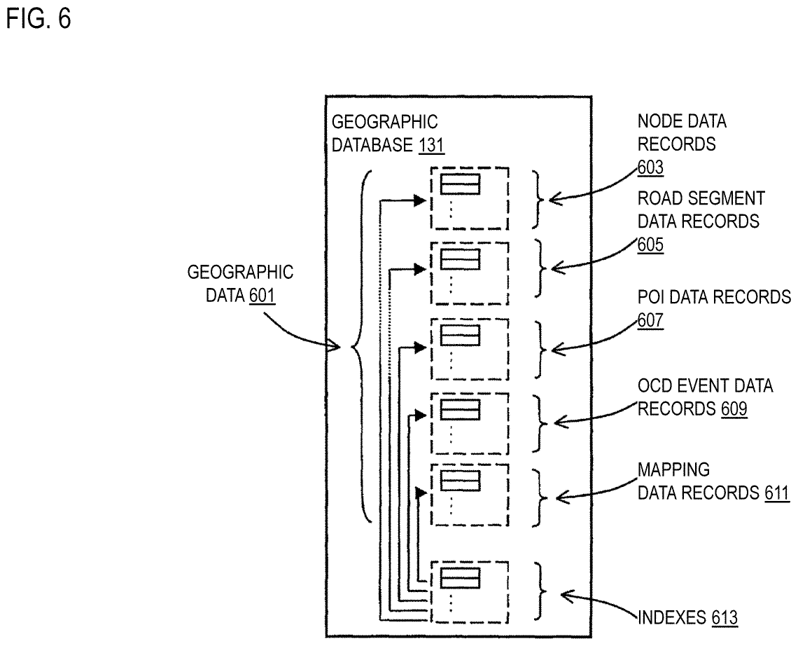

FIG. 6 is a diagram of a geographic database (such as the database 131), according to one embodiment. In one embodiment, the geographic database 131 includes geographic data 601 used for (or configured to be compiled to be used for) mapping and/or navigation-related services, such as for video odometry based on the parametric representation of lanes include, e.g., encoding and/or decoding parametric representations into lane lines. In one embodiment, the geographic database 131 include high resolution or high definition (HD) mapping data that provide centimeter-level or better accuracy of map features. For example, the geographic database 131 can be based on Light Detection and Ranging (LiDAR) or equivalent technology to collect billions of 3D points and model road surfaces and other map features down to the number lanes and their widths. In one embodiment, the mapping data (e.g., mapping data records 611) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 131.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 131 follows certain conventions. For example, links do not cross themselves and do not cross each other except at a node. Also, there are no duplicated shape points, nodes, or links. Two links that connect each other have a common node. In the geographic database 131, overlapping geographic features are represented by overlapping polygons. When polygons overlap, the boundary of one polygon crosses the boundary of the other polygon. In the geographic database 131, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 131 includes node data records 603, road segment or link data records 605, POI data records 607, OCD event data records 609, mapping data records 611, and indexes 613, for example. More, fewer or different data records can be provided. In one embodiment, additional data records (not shown) can include cartographic (“carto”) data records, routing data, and vehicle event data. In one embodiment, the indexes 613 may improve the speed of data retrieval operations in the geographic database 131. In one embodiment, the indexes 613 may be used to quickly locate data without having to search every row in the geographic database 131 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes. The node data records 603 are end points corresponding to the respective links or segments of the road segment data records 605. The road link data records 605 and the node data records 603 represent a road network, such as used by vehicles, vehicles, and/or other entities. Alternatively, the geographic database 131 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 131 can include data about the POIs and their respective locations in the POI data records 607. The geographic database 131 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city).

In one embodiment, the geographic database 131 can also include OCD event data records 609 for storing sensor data, OCD event data, historical OCD event data, vehicle idle/stop event data, driver cheating event data, passenger embarkment or dis-embarkment event data, parking data, training data, event prediction models, annotated event observations, computed event distributions, sampling probabilities, and/or any other data generated or used by the system 100 according to the various embodiments described herein. By way of example, the OCD event data records 609 can be associated with one or more of the node records 603, road segment records 605, and/or POI data records 607 to support localization or visual odometry based on the features stored therein and the corresponding estimated quality of the features. In this way, the records 609 can also be associated with or used to classify the characteristics or metadata of the corresponding records 603, 605, and/or 607.

In one embodiment, as discussed above, the mapping data records 611 model road surfaces and other map features to centimeter-level or better accuracy. The mapping data records 611 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 611 are divided into spatial partitions of varying sizes to provide mapping data to vehicles 101 and other end user devices with near real-time speed without overloading the available resources of the vehicles 101 and/or devices (e.g., computational, memory, bandwidth, etc. resources).

In one embodiment, the mapping data records 611 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 611.

In one embodiment, the mapping data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 131 can be maintained by the content provider 131 in association with the services platform 125 (e.g., a map developer). The map developer can collect geographic data to generate and enhance the geographic database 131. There can be different ways used by the map developer to collect data. These ways can include obtaining data from other sources, such as municipalities or respective geographic authorities. In addition, the map developer can employ field personnel to travel by vehicle (e.g., vehicles 101 and/or UEs 105) along roads throughout the geographic region to observe features and/or record information about them, for example. Also, remote sensing, such as aerial or satellite photography, can be used.

The geographic database 131 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101 or a UE 105, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for detecting a vehicle door opening or closing event based on sensor data collected during a vehicle idle/stop state may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

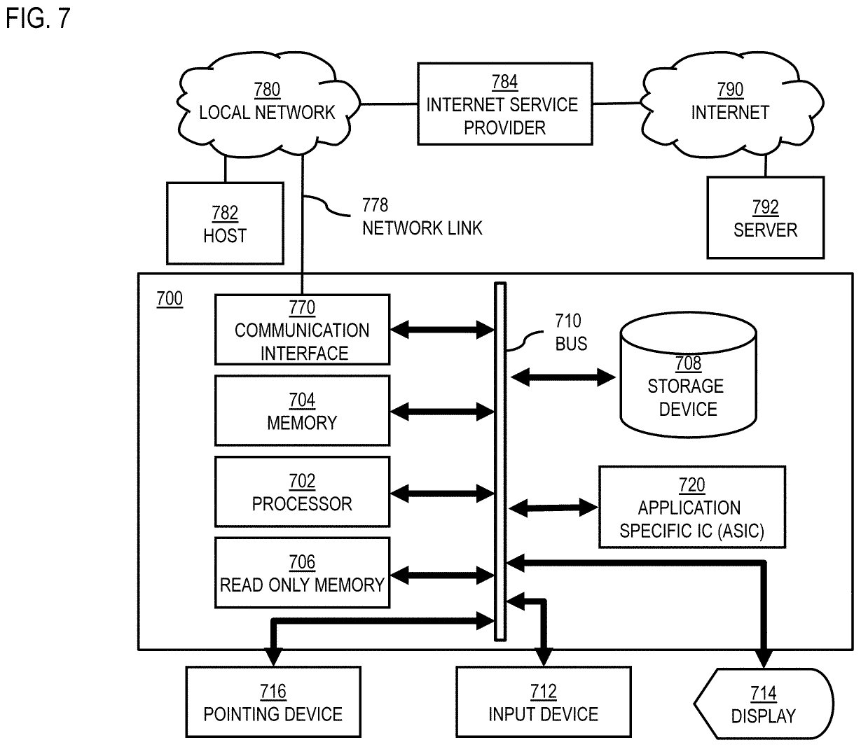

FIG. 7 illustrates a computer system 700 upon which an embodiment of the invention may be implemented. Computer system 700 is programmed (e.g., via computer program code or instructions) to detect a vehicle door opening or closing event based on sensor data collected during a vehicle idle/stop state as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to detecting a vehicle door opening or closing event based on sensor data collected during a vehicle idle/stop state. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RANI) or other dynamic storage device, stores information including processor instructions for detecting a vehicle door opening or closing event based on sensor data collected during a vehicle idle/stop state. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for detecting a vehicle door opening or closing event based on sensor data collected during a vehicle idle/stop state, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 123 for detecting a vehicle door opening or closing event based on sensor data collected during a vehicle idle/stop state (e.g., from the UE 105).

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system can be deployed in various configurations within other computer systems, e.g., host 782 and server 792.

FIG. 8 illustrates a chip set 800 upon which an embodiment of the invention may be implemented. Chip set 800 is programmed to detect a vehicle door opening or closing event based on sensor data collected during a vehicle idle/stop state as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to detect a vehicle door opening or closing event based on sensor data collected during a vehicle idle/stop state. The memory 805 also stores the data associated with or generated by the execution of the inventive steps.

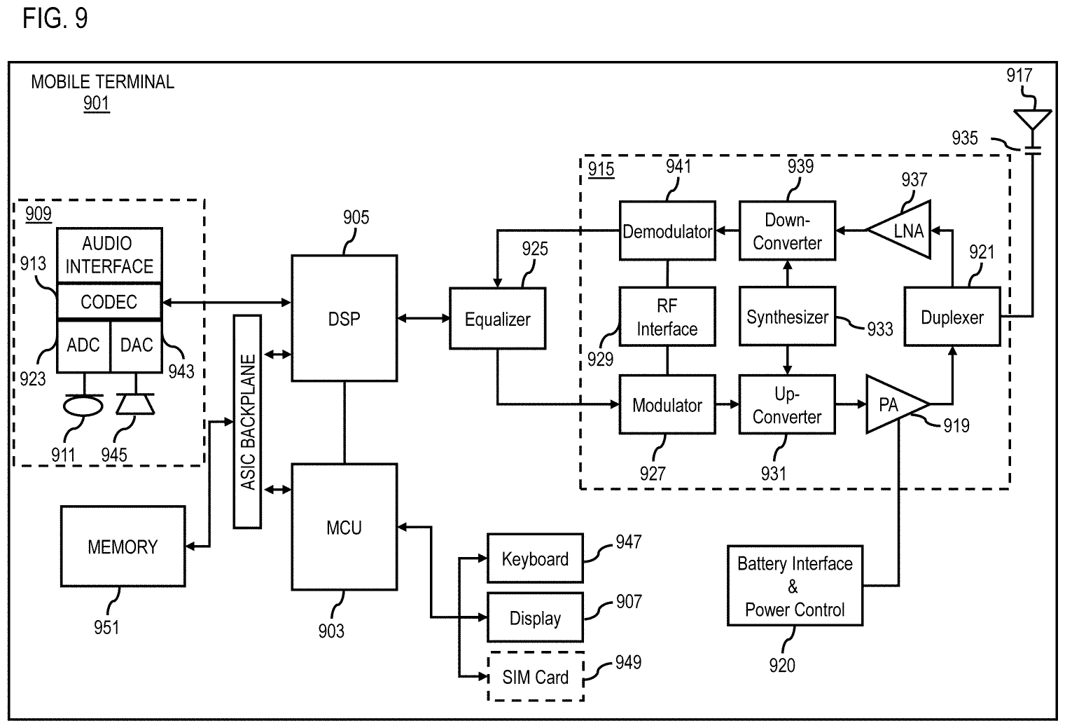

FIG. 9 is a diagram of exemplary components of a mobile terminal 901 (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to detect a vehicle door opening or closing event based on sensor data collected during a vehicle idle/stop state. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RANI memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
collecting sensor data from one or more sensors of a vehicle, a mobile device in the vehicle, or a combination thereof;
determining a time period when the vehicle is in an idle state based on the sensor data;
determining a vehicle door open event or a vehicle door close event based on pressure sensor data from at least one pressure sensor of the mobile device collected during the time period; and
providing the vehicle door open event or the vehicle door close event as an output.

2. The method of claim 1, wherein the vehicle door open event or the vehicle door close event is based on determining that the pressure sensor data indicates that an air pressure change is greater than a pressure change threshold.

3. The method of claim 2, wherein an air pressure change for the vehicle door open event is detected as a negative pressure change.

4. The method of claim 2, wherein an air pressure change for the vehicle door close event is a positive pressure change.

5. The method of claim 1, further comprising:
generating a pressure change profile indicating the air pressure change based on the pressure sensor data; and
determining one or more pressure decay rates from the pressure change profile,
wherein the vehicle door open event or the vehicle door close event is determined based on comparing the pressure change profile to a reference pressure profile, comparing the one or more pressure decay rates to a reference pressure decay rate, or a combination thereof.

6. The method of claim 5, wherein the reference pressure profile, the reference pressure decay rate, or a combination thereof is selected based on a type of the vehicle, a user of the vehicle, or a combination thereof.

7. The method of claim 1, wherein collecting of the pressure sensor data is initiated by determining that the vehicle is in an idle state.

8. The method of claim 1, further comprising:
processing the sensor data to detect one or more indications of the vehicle door open event or the vehicle door close event detected from the pressure sensor data; and
verifying the vehicle door close event or the vehicle door open event based on the one or more indications,
wherein the output is provided based on the verifying.

9. The method of claim 1, further comprising:
training a machine learning model to identify the vehicle door open event or the vehicle door close event based on the pressure sensor data, the sensor data, or a combination thereof.

10. The method of claim 1, further comprising:
determining a user embarkment or dis-embarkment event associated with the vehicle based on the vehicle door open event or the vehicle door close event.

11. The method of claim 10, further comprising:
processing the output to perform at least one of:
mapping a pickup or drop off area in a digital map, a database, or a combination thereof,
providing navigation routing data to the vehicle, the user, or a combination thereof, fleet management, and
vehicle dispatch.

12. An apparatus comprising:
at least one processor; and
at least one memory including computer program code for one or more programs,
the at least one memory and the computer program code configured to, with the at least one processor, cause the apparatus to perform at least the following,
collect sensor data from one or more sensors of a vehicle, a mobile device in the vehicle, or a combination thereof;
determine a time period when the vehicle is in an idle state based on the sensor data;
determine a vehicle door open event or a vehicle door close event based on pressure sensor data from at least one pressure sensor of the mobile device collected during the time period; and
provide the vehicle door open event or the vehicle door close event as an output.

13. The apparatus of claim 12, wherein the vehicle door open event or the vehicle door close event is based on determining that the pressure sensor data indicates that an air pressure change is greater than a pressure change threshold.

14. The apparatus of claim 13, wherein an air pressure change for the vehicle door open event is detected as a negative pressure change.

15. The apparatus of claim 13, wherein an air pressure change for the vehicle door close event is a positive pressure change.

16. The apparatus of claim 12, wherein the apparatus is further caused to:
generate a pressure change profile indicating the air pressure change based on the pressure sensor data; and
determine one or more pressure decay rates from the pressure change profile,
wherein the vehicle door open event or the vehicle door close event is determined based on comparing the one or more pressure decay rates to a reference pressure decay rate.

17. The apparatus of claim 16, wherein the reference pressure decay rate is selected based on a type of the vehicle, a user of the vehicle, or a combination thereof.

18. A non-transitory computer-readable storage medium carrying one or more sequences of one or more instructions which, when executed by one or more processors, cause an apparatus to perform:
collecting sensor data from one or more sensors of a vehicle, a mobile device in the vehicle, or a combination thereof;
determining a time period when the vehicle is in an idle state based on the sensor data;
determining a vehicle door open event or a vehicle door close event based on pressure sensor data from at least one pressure sensor of the mobile device collected during the time period; and
providing the vehicle door open event or the vehicle door close event as an output.

19. The non-transitory computer-readable storage medium of claim 18, wherein the vehicle door open event or the vehicle door close event is based on determining that the pressure sensor data indicates that an air pressure change is greater than a pressure change threshold.

20. The non-transitory computer-readable storage medium of claim 19, wherein an air pressure change for the vehicle door open event is detected as a negative pressure change.
